(19) United States
(12) Patent Application Publication
(10) Pub. No.: US 2016/0173749 A1
(43) Pub. Date: Jun. 16, 2016

(54) STILL IMAGE CAPTURE WITH EXPOSURE CONTROL

(71) Applicant: OMG PLC, Oxford Oxfordshire (GB)

(72) Inventors: James Andrew DALLAS, London (GB); James Alexander LEIGH, London (GB)

(21) Appl. No.: 14/905,855

(22) PCT Filed: Jul. 18, 2014
(86) PCT No.: PCT/GB2014/052209

§ 371 Date: Jan. 18, 2016

(30) Foreign Application Priority Data
Jul. 18, 2013 (GB) 1312892.1

(51) Int. Cl. H04N 5/232; G06K 9/46; H04N 5/235

(52) U.S. Cl. CPC H04N 5/2327; H04N 5/2353; G06K 9/4661

(57) ABSTRACT

A camera unit that comprises an image sensor and a motion sensor performs an image capture operation in which still images are captured intermittently without triggering by a user. The brightness of illumination during the capture of images is determined. Exposure time is controlled in dependence on both the brightness of illumination and the detected motion.

The present invention relates to a camera unit that comprises an image sensor that is operable to capture still images, and in some embodiments a camera unit captures images intermittently without a triggering by the user.

A first aspect of the present invention is concerned with exposure control. Image capture by a camera unit can occur in a variety of lighting conditions. Since any image sensor has a limited dynamic range, the exposure of the image sensor needs to be controlled to accommodate the variation in illumination. Exposure may be controlled by varying the exposure time which involves control of the image sensor. In some camera units, exposure may also be controlled by varying the aperture, although low-cost camera units might use a camera lens assembly that does not permit that. Much development of automatic exposure control has occurred.

One known approach to automatic exposure control is as follows. Successive images are captured and the brightness of illumination is detected, for example by deriving a measure of the brightness of each captured image. The exposure of captured images may then be controlled in dependence on the brightness measures of previously captured images. For example, the exposure of captured images may be controlled to drive the brightness measure towards a target level. When the exposure has converged, the final captured image is stored, and the other captured images are discarded on the basis of having sub-optimal exposure.

In general terms, the exposure control must balance a number of competing factors. The exposure should be sufficiently high to provide an image with a brightness at a sufficient level. However, increasing the exposure time to increase the exposure can create the problem of motion blur in the image derived from motion of the camera unit across the exposure time. Many standard forms of automatic exposure control can produce significant motion blur for a proportion of images in normal usage. On the other hand, reducing the exposure may make it difficult for the camera unit to accommodate scenes having relatively low illumination (“low light scenes”). Many standard forms of automatic exposure control can produce images of low brightness in normal usage.

Most digital still camera images are taken while the camera unit is stationary, with a user pointing the camera unit, framing the shot, checking the image quality in a preview mode, and altering the camera direction, framing, or other settings such as exposure until they have a satisfactory shot. This minimises change during the image capture operation to the scene being imaged. However, even in this situation, in practice motion blur is evident in a proportion of images captured by typical users.

These problems are exacerbated in the case of a camera unit that comprises a control circuit that controls the image sensor to capture images intermittently without a user triggering capture of the individual images. Such a camera unit may, for example, capture images in response to sensors that sense physical parameters of the camera unit or its surroundings. That allows for intelligent decisions on the timing of image captures, in a way that increases the chances of the images being of scenes that are significant to the user.

In general, since the camera unit captures images without a user triggering capture, the user does not know the intermittent times at which image capture will occur. Thus, image capture occurs whilst the user moves naturally through variable lighting conditions and there is a greater chance of the camera unit being directed at a scene that is difficult to expose correctly and there is no possibility of the user taking any positive action to correct or improve exposure, for example by pointing, framing and or adjusting exposure quality, and the conditions are not stable during the image capture operation.

Furthermore, such a camera unit might typically have a relatively wide field of view. This is to compensate for the fact that the camera unit will typically not be directed at a scene that has a natural point of interest since the user does not know when image capture will occur. However, such a wide field of view increases the chances of a situation where the scene being imaged has a greater dynamic range than the image sensor, which may be a small image sensor suited to a wearable device.

Some existing approaches for dealing with this issue are as follows.

Reduction of motion blur can be achieved by a mechanical optical image stabilisation (OIS) system that moves one or more of the optical components or sensor to compensate for motion of the camera unit that may be detected by a motion sensor. However, such a mechanical OIS system is expensive and increases the size and complexity of the camera unit, adding difficulty during manufacture. Furthermore, such a mechanical OIS system also consumes power during operation which reduces battery life, this being a particular issue for a wearable camera.

Reduction of motion blur can be achieved by image processing. However, this is difficult to perform effectively in practice and generally it is considered better to avoid motion blur in an image than to correct it after capture. Such image processing techniques generally assume a global shuttering and so perform less well for rolling shuttering which is more common on an image sensor of low cost. Furthermore, such image processing techniques are relatively complex and slow, and increase the processing requirement. This makes such techniques less attractive as the number of images captured increases, as for example is typical in a camera unit that captures images intermittently.

Many motion blur solutions have previously been aimed at general purpose cameras, or machine vision systems, both of which have different constraints from a camera unit that captures images intermittently.

Dealing with low light scenes is usually addressed by use of a flash unit or use of a still or stabilized platform to support the camera. However, these approaches are not practical in all situations. A flash consumes significant power and impacts battery drain. Furthermore, the flash of light from the flash unit may be unacceptable to the user in some situations. The flash of light might typically be unacceptable to the user for a camera unit that captures images intermittently, because such a camera unit may capture relatively large numbers of images during activities in which the user will not wish to be interrupted. Use of a still or stabilized platform is inconvenient to set up in a way that may be entirely unacceptable to the user. Use of a still or stabilized platform might typically be unacceptable to the user for a camera unit that captures images intermittently, because the user does not know the intermittent times at which image capture will occur and will typically bear the camera unit while undertaking other activity.

An additional point is that the issues are more difficult for still images than for video images. This is because video tends to converge to the correct exposure over time as the lighting context changes. In contrast individual still images tend to be viewed for a longer time and so the perceived quality threshold may be higher than video.

The first aspect of the present invention is concerned with improving exposure control.

According to the first aspect of the present invention, there is provided a method of controlling a camera unit that comprises an image sensor arranged to capture still images and a motion sensor arranged to detect motion of the camera unit, the method comprising:

capturing still images;

determining the brightness of illumination during the capture of images;

detecting motion of the camera unit during the capture of images; and

during the capture of images, controlling the exposure time in dependence on both the determined brightness of illumination of the captured images and the detected motion; and

storing a captured image.

In this method, the exposure time is controlled on the basis of not only the brightness of illumination but also the motion of the camera unit detected by a motion sensor with which the camera unit is provided. The brightness of illumination may be used in a similar manner to known automatic exposure control systems. However, advantage is obtained by additionally taking account of the motion. This allows the exposure control to be improved in a number of ways.

The use of the detected motion allows the exposure control to be adapted to take account of the detected motion in a way that the exposure time may be optimised without image quality being impacted by motion blur. For example, the exposure time may be initially selected on the basis of the determined brightness of illumination and may be reduced from the initially selected exposure time in the event that the detected motion is indicative of an unacceptable degree of blurring. Such a reduction in the exposure time reduces the motion blur. This is at the detriment of exposure time which may cause the image to be darker or noisier than it would otherwise be, but that has less impact on the perceived quality than motion blur.

Furthermore, this improvement reduces the requirement for a mechanical OIS system that would increase the bulk and cost of the camera or for an image processing systems that would increase the processing requirements and cost of the associated circuitry. Similarly, this improvement reduces the requirement for a flash unit or for the provision of a still or stabilised platform.

This has particular advantage when applied to a camera unit in which the method is performed intermittently without triggering by a user, for example a camera unit that comprises plural sensors arranged to sense physical parameters of the camera unit or its surroundings, in which case the method may be performed intermittently in response to the outputs of the sensors. As discussed above, in such a camera unit the problems addressed by the first aspect of the present invention are exacerbated, because image capture occurs whilst the user moves naturally through variable lighting conditions, without the user taking action to improve image quality. Thus, the benefits obtained are of more importance.

A second aspect the present invention is concerned with blurring of captured images caused by motion of the camera unit, referred to herein as motion blur, as opposed to motion of objects within a scene being imaged.

Many standard forms of automatic exposure control can produce motion blur that may be significant for a proportion of images in normal usage.

Most digital still camera images are taken while the camera unit is stationary, with a user pointing the camera unit, framing the shot, checking the image quality in a preview mode, and altering the camera direction, framing, or other settings such as exposure until they have a satisfactory shot. This minimises change during the image capture operation to the scene being imaged. However, even in this situation, motion blur is in practice evident in a proportion of images captured by typical users.

These problems are exacerbated in the case of a camera unit that comprises a control circuit that controls the image sensor to capture images intermittently without a user triggering capture of the individual images. Such a camera unit may, for example, capture images in response to sensors that sense physical parameters of the camera unit or its surroundings. That allows for intelligent decisions on the timing of image captures, in a way that increases the chances of the images being of scenes that are significant to the user.

In general, since the camera unit captures images without a user triggering capture, the user does not know the intermittent times at which image capture will occur. Thus, image capture occurs whilst the user moves naturally through variable lighting conditions and there is a greater chance of the camera unit being directed at a scene that is difficult to expose correctly and there is no possibility of the user taking any positive action to correct or improve exposure, for example by pointing, framing and or adjusting exposure quality, and the conditions are not stable during the image capture operation.

Furthermore, such a camera unit might typically have a relatively wide field of view. This is to compensate for the fact that the camera unit will typically not be directed at a scene that has a natural point of interest since the user does not know when image capture will occur. However, such a wide field of view increases the chances of a situation where the scene being imaged has a greater dynamic range than the image sensor, which may be a small image sensor suited to a wearable device.

Some existing approaches for dealing with this issue are as follows.

Reduction of motion blur can be achieved by a mechanical optical image stabilisation (OIS) system that moves one or more of the optical components or sensor to compensate for motion of the camera unit that may be detected by a motion sensor. However, such a mechanical OIS system is expensive and increases the size and complexity of the camera unit, adding difficulty during manufacture. Furthermore, such a mechanical OIS system also consumes power during operation which reduces battery life, this being a particular issue for a wearable camera.

Reduction of motion blur can be achieved by image processing. However, this is difficult to perform effectively in practice and generally it is considered better to avoid motion blur in an image than to correct it after capture. Such image processing techniques generally assume a global shuttering and so perform less well for rolling shuttering which is more common on an image sensor of low cost. Furthermore, such image processing techniques are relatively complex and slow, and increase the processing requirement. This makes such techniques less attractive as the number of images captured increases, as for example is typical in a camera unit that captures images intermittently.

Many motion blur solutions have previously been aimed at general purpose cameras, or machine vision systems, both of which have different constraints from a camera unit that captures images intermittently.

Dealing with low light scenes is usually addressed by use of a flash unit or use of a still or stabilized platform to support the camera. However, these approaches are not practical in all situations. A flash consumes significant power and impacts battery drain. Furthermore, the flash of light from the flash unit may be unacceptable to the user in some situations. The flash of light might typically be unacceptable to the user for a camera unit that captures images intermittently, because such a camera unit may capture relatively large numbers of images during activities in which the user will not wish to be interrupted. Use of a still or stabilized platform is inconvenient to set up in a way that may be entirely unacceptable to the user. Use of a still or stabilized platform might typically be unacceptable to the user for a camera unit that captures images intermittently, because the user does not know the intermittent times at which image capture will occur and will typically bear the camera unit while undertaking other activity.

An additional point is that the issues are more difficult for still images than for video images. This is because video tends to converge to the correct exposure over time as the lighting context changes. In contrast individual still images tend to be viewed for a longer time and so the perceived quality threshold may be higher than video.

A second aspect of the present invention relates to movement of the camera unit over the image capture operation.

While still images are captured repeatedly in a cycle and the exposure is being controlled, there may be changes in scene being imaged, most significantly due to movement of the camera, but also due to movement of objects within the scene, and there may be other changes in conditions. This may disrupt the exposure control in a way that is detrimental to the quality of the ultimately captured image.

Most digital still camera images are taken while the camera unit is stationary, with a user pointing the camera unit, framing the shot, checking the image quality in a preview mode, and altering the camera direction, framing, or other settings such as exposure until they have a satisfactory shot. This minimises change during the image capture operation to the scene being imaged. However, even in this situation, there may be some change within the scene being imaged that is detrimental to image quality.

However, this problem is exacerbated in the case of a camera unit that comprises a control circuit that controls the image sensor to capture images intermittently without a user triggering capture of the individual images. Such a camera unit may, for example, capture images in response to sensors that sense physical parameters of the camera unit or its surroundings. That allows for intelligent decisions on the timing of image captures, in a way that increases the chances of the images being of scenes that are significant to the user. In general, since the camera unit captures images without a user triggering capture, image capture occurs whilst the user moves naturally through variable lighting conditions and the user does not know the intermittent times at which image capture will occur. Thus, there is a greater chance that the conditions are not stable during the image capture operation, and there is no possibility of the user taking any positive action to deal with this.

Furthermore, such a camera unit might typically have a relatively wide field of view. This is to compensate for the fact that the camera unit will typically not be directed at a scene that has a natural point of interest since the user does not know when image capture will occur. However, such a wide field of view increases the chances of the scene changing during the image capture operation.

The second aspect of the present invention is concerned with tackling this issue.

According to the second aspect of the present invention, there is provided a method of controlling a camera unit that comprises an image sensor arranged to capture the images, the method comprising:

capturing still images repeatedly in a cycle and buffering at least some of the captured images;

determining the brightness of illumination during the capture of images, and, in said step of capturing still images repeatedly in a cycle, controlling the exposure on the basis of the determined brightness;

deriving a quality metric in respect of the buffered images; and

storing a buffered image having the highest quality metric and discarding the other buffered images.

This method performs the capture of still images repeatedly in a cycle whilst controlling the exposure on the basis of the brightness of illumination. This may be implemented in a similar way to known automatic exposure control systems. However, such known automatic exposure control systems typically store the final image since that is the target of the convergence designed to optimise the image quality. In contrast, the method provides an advantage on the basis of an understanding that, due to motion changes in the scene being imaged as between the captured images, it might in some circumstances be the case that the final image does not have the best image quality.

Accordingly, the method involves buffering at least some of the captured images, deriving a quality metric in respect of the buffered images, and storing a buffered image having the highest quality metric, the other buffered images being discarded. Even though the final image has the final exposure derived by the automatic exposure, it has been appreciated that in practice the final image might in fact be of lower quality than one of the earlier images, due to factors other than exposure, for example motion of the camera unit causing varying degrees of blurring. Thus, the method stores the image that is of best quality as measured by the quality metric, even in the case that this is not the final image. Overall, this improves the quality of captured images.

The quality metric may take into account the brightness measure of the image and at least one further parameter. By taking into account the brightness measure, the quality metric tends to select images having better brightness, without being solely dependent on brightness.

In the case that the camera apparatus further comprises a motion sensor arranged to detect motion of the camera unit, and the quality metric may take into account the blurring of the image indicated by the detected motion. That may provide the advantage of allowing the method to select an image that is of higher quality than the final image, because it happens to be captured at a moment when motion blur is low, even if the exposure is not optimum.

The second aspect of the present invention has particular advantage when applied to a camera unit in which the method is performed intermittently without triggering by a user, for example a camera unit that comprises plural sensors arranged to sense physical parameters of the camera unit or its surroundings, in which case the method may be performed intermittently in response to the outputs of the sensors. As discussed above, in such a camera unit image capture occurs whilst the user moves naturally through variable lighting conditions, without the user taking action to improve image quality, and so there is a greater likelihood of the conditions being unstable during the image capture operation in a way resulting in an image other than the final one being of best quality.

The following comments apply to the use of the detected motion to indicate blurring of an image in each of the two aspects of the present invention.

Motion of a camera unit can be broken into two components, that is rotational motion and translational motion. In general both components contribute to motion blur and so may be used together.

However, particular advantage is achieved when the motion sensor is a gyroscope sensor and the detected motion of the camera unit is angular motion of the camera unit around at least one axis, preferably around three orthogonal axes. This has proven effective, because during normal use rotational motion typically provides a larger degree of motion blur than translational motion, during a single image exposure, and also because the amount of image blur caused by rotation is independent of scene depth. Thus, use of rotational motion to indicate the degree of blurring has been observed to provide greater effectiveness than translational motion.

When using rotational motion around three orthogonal axes, rotation around each axis may be considered separately. However, further advantage may be achieved by use of a blur measure derived from a combination of the angular motion around two or preferable each of the three orthogonal axes. As the blur is influenced by the rotation around each axis in combination, in practice use of a combined measure has been observed to provide better results than considering measures of rotation around each axis separately.

The combination may be a weighted sum of the angular motion around each of three orthogonal axes, wherein the weights might typically not be identical. In particular, the weights may be scaled relative to each other by factors that are based on the amount of blur measured relative to the pixel pitch.

Furthermore, the method may be applied to an image sensor that is globally shuttered or an image sensor that is rolling shuttered. In the case of global shuttering, the blur measure may be the weighted sum of the angular motion around each of the three orthogonal axes detected by the gyroscope sensor, detected over the exposure time of the image sensor. In the case of rolling shuttering, the blur measure may be a combination, e.g. a weighted sum, of blur values in respect of each line that are the weighted sum of the angular motion around each of the three orthogonal axes detected by the gyroscope sensor, detected over the exposure time of respective lines.

Further according to the each of the two aspects of the present invention, there is provided a camera unit comprising an image sensor and a control circuit for controlling the camera unit that is arranged to perform an image capture operation similar to the method.

The two aspects of the present invention may be implemented together. Thus, the variously described features of the two aspects described and claimed herein may be implemented together in any combination.

An embodiment of the present invention will now be described by way of non-limitative example with reference to the accompanying drawings, in which:

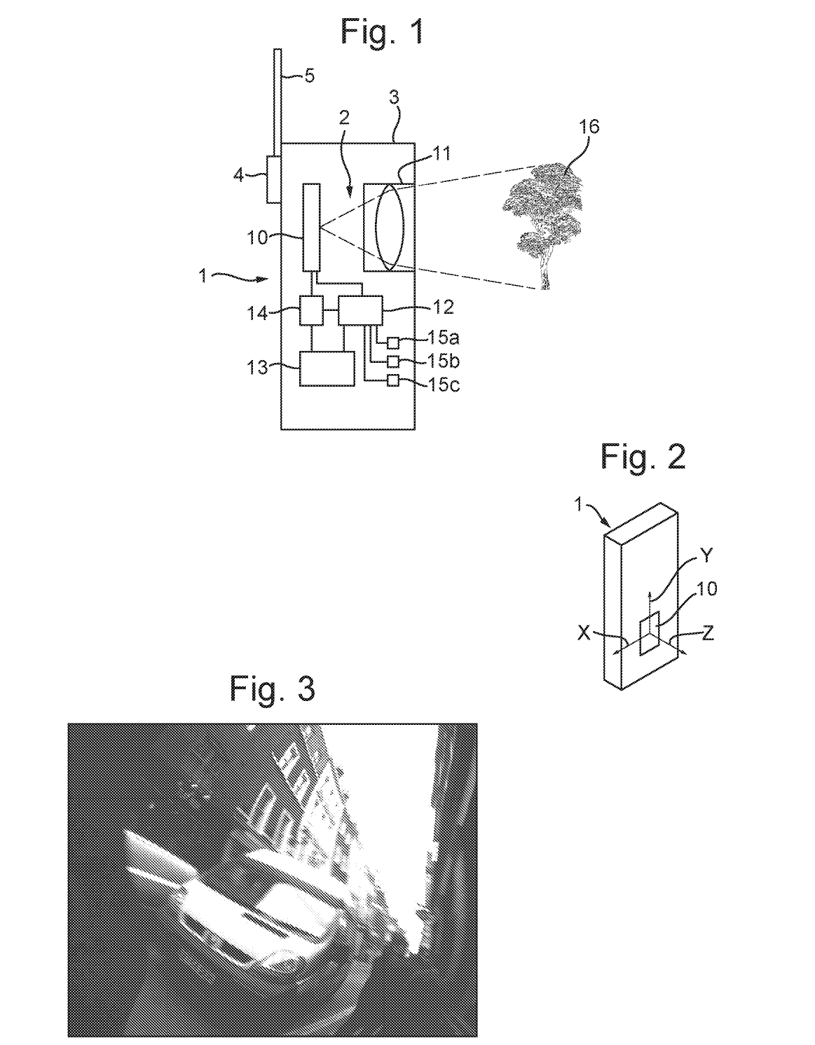

FIG. 1 is a schematic block diagram of a camera;

FIG. 2 is a schematic view of the camera showing the alignment of rotational axes with the image sensor;

FIG. 3 is a sample image;

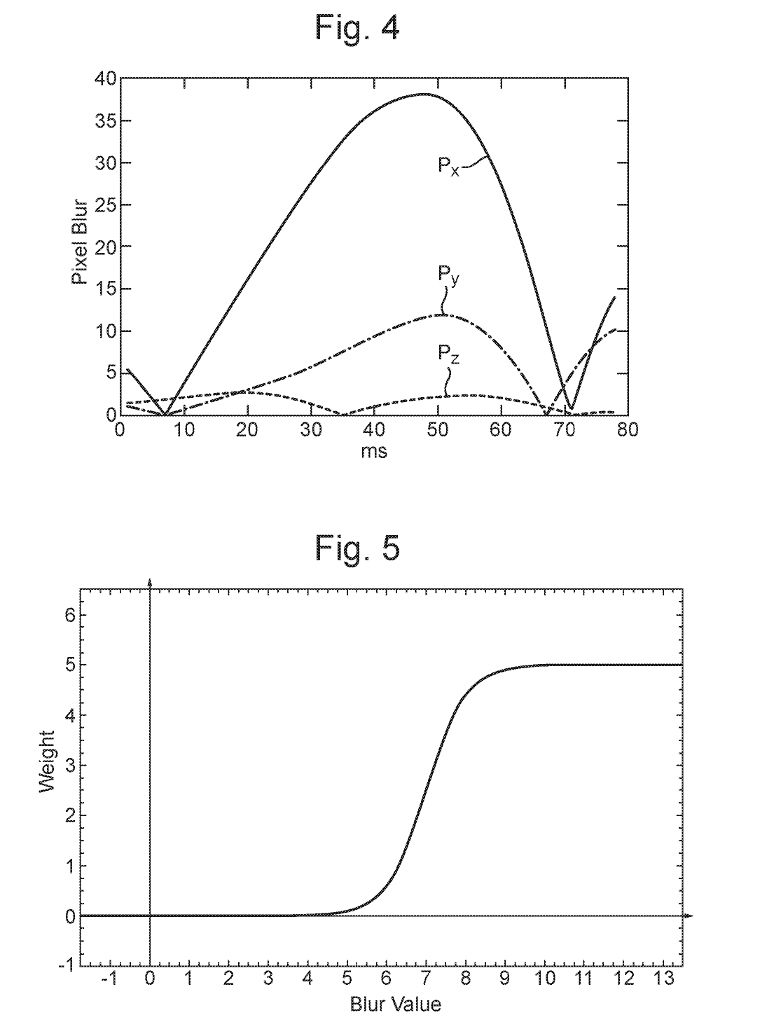

FIG. 4 is a graph of the pixel blur over time during capture of the sample image of FIG. 3;

FIG. 5 is a graph of a sigmoid function of weight against blur value;

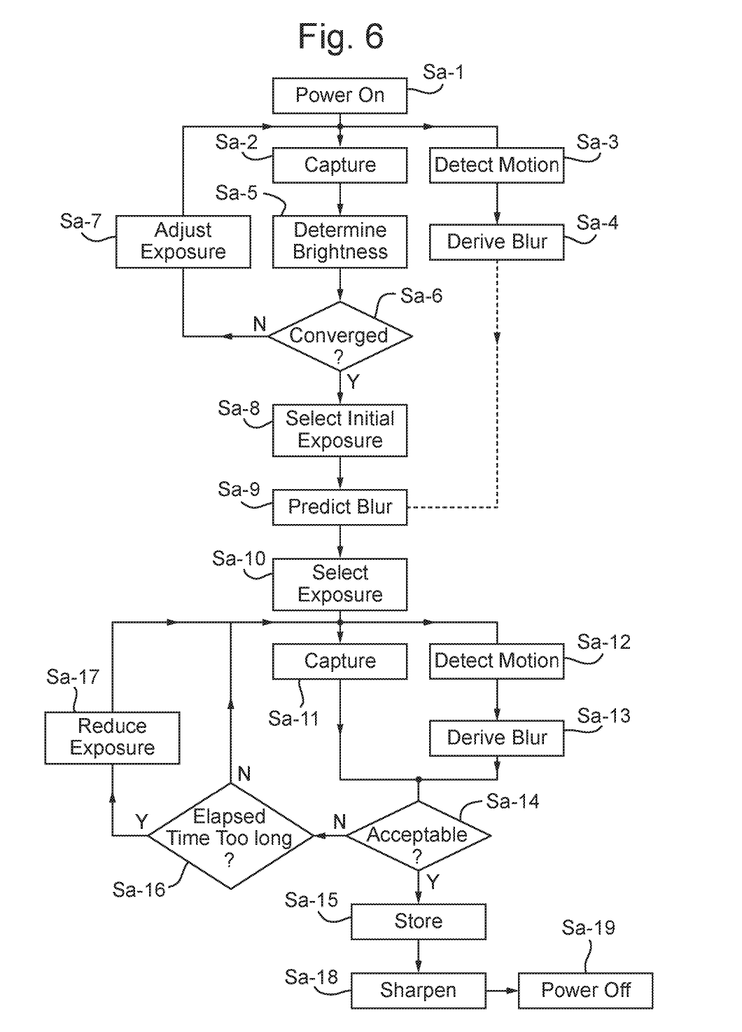

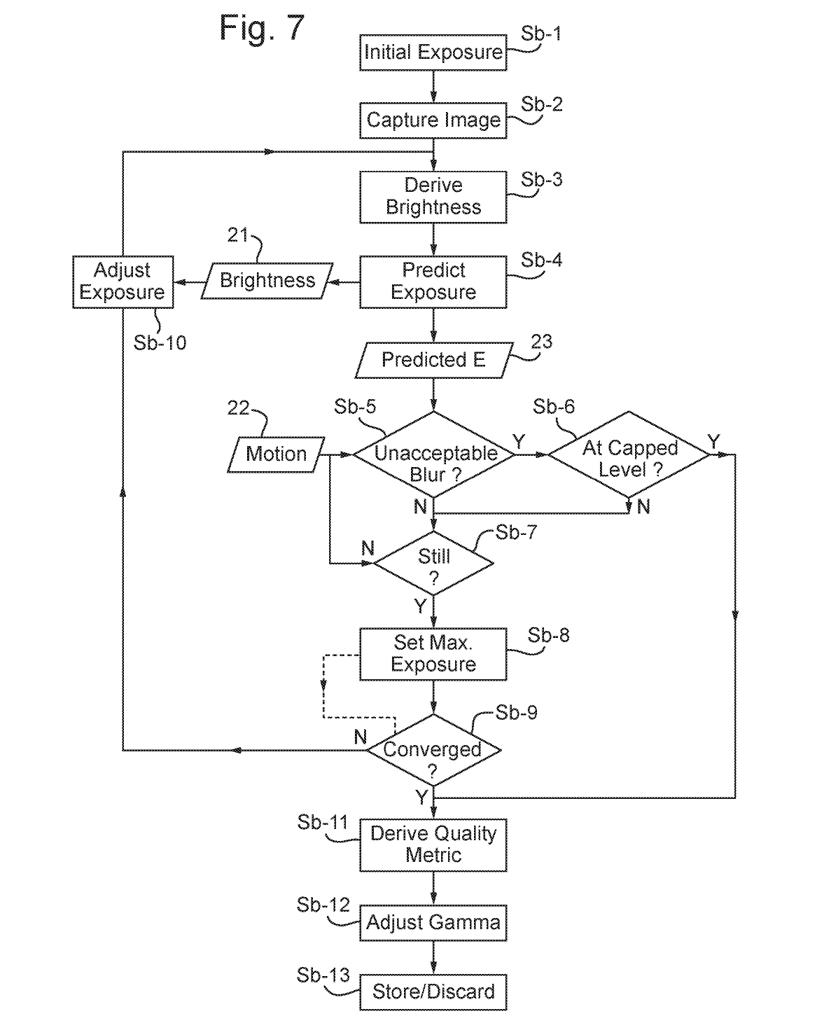

FIG. 6 is a flow chart of a first method of capturing images that is implemented in the camera; and

FIG. 7 is a flow chart of a second method of capturing images that is implemented in the camera.

FIG. 1 is a schematic block diagram of a camera 1 comprising a camera unit 2 mounted in a housing 3. The camera 1 is wearable. To achieve this, the housing 3 has a fitment 4 to which is attached a lanyard 5 that may be placed around a user's neck. Other means for wearing the camera 1 could alternatively be provided, for example a clip to allow attachment to a user's clothing.

The camera unit 2 comprises an image sensor 10 and a camera lens assembly 11 in front face of the housing 13. The camera lens assembly 11 focuses an image of a scene 16 on the image sensor 10 which captures the image and may be of any suitable type for example a CMOS (complimentary metal-oxide-semiconductor) device. The camera lens assembly 11 may include any number of lenses and may provide a fixed focus that preferably has a wide field of view.

The size of the image sensor 10 has a consequential effect on the size of the other components and hence the camera unit 2 as a whole. In general, the image sensor 10 may be of any size, but since the camera 1 is to be worn, the image sensor 10 is typically relatively small. For example, the image sensor 10 may typically have a diagonal of 6.00 mm (corresponding to a ⅓″ format image sensor) or less, or more preferably 5.68 mm (corresponding to a 1/3.2″ format image sensor) or less. In one implementation, the image sensor has 5 megapixels in a 2592-by-1944 array in a standard 1/3.2″ format with 1.75 μm square pixels, producing an 8-bit raw RGB Bayer output, having an exposure time of the order of milliseconds and an analogue gain multiplier.

In normal use, the camera unit 2 will be directed generally in the same direction as the user, but might not be directed at a scene that has a natural point of interest since the user does not know when image capture will occur. For this reason, it is desirable that the camera lens assembly 11 has a relatively wide field of view (“wide angle”). For example, the camera lens assembly 11 may typically have a diagonal field of view of 85 degrees or more, or more preferably 100 degrees or more.

The camera unit 2 includes a control circuit 12 that controls the entire camera unit 2. The control circuit 12 controls the image sensor 10 to capture still images that may be stored in a memory 13. The control circuit 12 may be implemented by a processor running an appropriate program. The control circuit 12 may include conventional elements to control the parameters of operation of the image sensor 10 such as exposure time. Similarly, the memory 13 may take any suitable form, a non-limitative example being a flash memory that may be integrated or provided in a removable card.

A buffer 14 is included to buffer captured images prior to permanent storage in the memory 13. The buffer 14 may an integrated element separate from the memory 13, or may be a region of the memory 13 selected by the control circuit 12.

The camera unit 2 further includes plural sensors 15 that sense different physical parameters of the camera unit 2 or its surroundings (three sensors 15a to 15c being shown in FIG. 1 for illustration, although any number may be provided).

The sensors 15 include a gyroscope sensor 15a arranged to detect angular motion, in particular angular velocity of the camera unit 2 around three orthogonal axes. As an example, the gyroscope sensor 15a may be implemented by a MEMS (Micro-Electro-Mechanical System) gyroscope. The amount of angular rotation may be obtained by integrating the detected angular velocity around each axis. Thus, the gyroscope sensor 15a is an example of a motion sensor that detects motion of the camera unit 2.

More generally, the sensors 15 may include other types of motion sensor that detect motion of the camera unit 2, for example translational and/or angular motion, that may be velocity and/or acceleration. As an example, the sensors 15 may include an accelerometer that detects translational acceleration of the camera unit 2.

Other non-limitative examples of the types of sensing and sensors 15 include: sensing of location of the camera unit 2 for example using a GPS (global positioning system) receiver; sensing of ambient light using a light sensor; sensing of magnetic fields using a magnetometer; sensing of motion of external objects using an external motion sensor, that may be for example an infra-red motion sensor; sensing of temperature using a thermometer; and sensing of sound.

The control circuit 12 performs the image capture operation intermittently without being triggered by the user. The control circuit 12 may perform the image capture operation based on various criteria, for example in response to the outputs of the sensors 15, or based on the time elapsed since the previous image capture operation, or on a combination of these and/or other criteria. The user does not generally know when image capture will occur and so will not be taking any specific action to improve image quality.

In the case of triggering in response to the outputs of the sensors 15, capture of images may be triggered when the outputs of the sensors 15 indicate a change or a high level on the basis that this suggests occurrence of an event that might be of significance to the user. Capture may be triggered based on a single sensor or a combination of sensors 15. That allows for intelligent decisions on the timing of image captures, in a way that increases the chances of the images being of scenes that are in fact significant to the user. Images are captured intermittently over a period of time, for example by capturing an image when the period since the last capture exceeds a limit, or by over time reducing the thresholds on the outputs of the sensors used for triggering. Thus, image capture occurs whilst the user moves naturally through variable lighting conditions.

Exposure of the image sensor 10 during image capture may be controlled by the control unit 12. Exposure control may be performed by controlling the operation of the image sensor 10 to vary the exposure time. Optionally, the camera lens assembly 11 may also be controllable to vary the exposure, for example by varying the optical aperture, but this might not be implemented in a low-cost camera unit 2. If so implemented, then exposure control may also be performed by controlling the camera lens assembly 11.

The control circuit 12 performs an image capture operation to capture and store and image, in a manner described in more detail below. During the performance of such an image capture operation, the control circuit 12 derives and uses a blur measure representing the degree of blurring for captured images from the angular motion detected by the gyroscope sensor 15a. The derivation of the blur measure will now be described.

FIG. 2 illustrates the orientation of three orthogonal axes with respect to the image sensor 10 of the camera 1. These axes are a first axis X and a second axis Y each in the plane of the image sensor 10 and a third axis Z perpendicular to the plane of the image sensor 10. The first and second axes are aligned with the major axes of the rectangular shape of the image sensor 10. In the orientation shown in FIG. 2 the first axis X is horizontal, but of course the camera 1 could be used in any orientation.

The three axes shown in FIG. 2 are used as a reference frame in this example. This is convenient, because the axes are aligned with the geometry of the image sensor 10. However, in general any set of orthogonal axes could be used as a reference frame. Different reference frames are related by linear combinations representing the rotational transformation between them. This means that the calculations described below applied to a different reference frame produce the same blur measure irrespective of the reference frame. Similarly, if the reference frame of the angular rotations detected by the gyroscope sensor 15a are not already aligned with the reference frame shown in FIG. 2, then they may be converted into that reference frame by a simple linear combinations of the detected angular rotations.

It has been appreciated that the angular motion around each of three orthogonal axes generates blurring of captured images. Rotation around the first axis X generates motion blur linearly along the second axis Y. Rotation around the second axis Y generates motion blur linearly along the first axis X. Rotation around the third axis Z generates motion blur circularly around the centre of image. Thus, the motion blur caused by rotation around the first axis X and the second axis Y will be the same at each location on the image that is exposed simultaneously, whereas the motion blur caused by rotation around the third axis Z will be of different direction and magnitude at different locations on the image that are exposed simultaneously. These motion blurs combine to produce an overall blurring of the image, that may be different at different locations on the image either in the case of rotation around the third axis Z or in the case of different locations on the image being exposed at different times.

As the motion blurs combine, the blur measure is derived from a combination of the angular motion detected around each of three axes. This combination may be a blur value B that is a weighted sum given by the following equation

B=wₓ·θₓ+w_{y}·θ_{y}+w_{z}·θ_{z}

where θᵢ are the amounts of angular motion around the respective axes that occurs during exposure and wᵢ are the weights in respect of each of the three axes. The weights wᵢ are scaled relative to each other by factors that are based on the amount of blur measured relative to the pixel pitch, as follows.

By way of definition, the amount of blur measured relative to the pixel pitch, that is in units of the pixel pitch, will be referred to as the pixel blur. The pixel blur may be derived from the amounts of angular motion θᵢ around the respective axes as follows.

By assuming the field of view varies linearly across the image, the pixel blur Pₓ along the first axis X and the pixel blur P_{y} along the second axis Y may be scaled by respective scaling factors Sₓ and S_{y}, relative to the amount of angular motion θ_{y} around the second axis Y and the amount of angular motion θₓ around the second axis X during exposure, respectively, using the following equations:

Pₓ=Sₓ·θ_{y}=(Rₓ/Fₓ)·θ_{y}

P_{y}=S_{y}·θₓ=(R_{y}/F_{y})·θₓ

where Rₓ and R_{y} are the pixel resolutions (in pixels) of the image sensor 10 along the first axis X and the second axis Y, and Fₓ and F_{y} are the fields of view (in the same angular units as angular motion) of the camera unit 2 along the first and second axes.

The pixel blur caused by a rotation about the third axis Z varies with the distance from the centre of rotation. Therefore, the pixel blur P_{z} around the third axis is considered to be the pixel blur along largest circle that fits in the image. The length of such a circle is π·d, where d is the size of the image sensor 10 in the direction of its shortest axis, and so the pixel blur P_{z} around the third axis Z may be derived taking into account the pixel resolution in that direction. In the case that the second axis Y is shorter than the first axis X, then the pixel blur P_{z} around the third axis Z may be scaled by a scaling factor S_{z} relative to the amount of angular motion θ_{z} around the third axis Z using the following equation:

P_{z}=S_{z}·θ_{z}=(π·R_{y}/T)·θ_{z}

where R_{y} is the pixel resolution (in pixels) of the image sensor 10 along the second axis Y, and T is a full turn (in the same angular units as angular motion). In the case that the first axis X is shorter than the second axis Y, then the same equation is used substituting x for y.

The weights wᵢ are scaled relative to each other by factors that are based on these scaling factors Si to take account of the pixel blur caused by the rotation in different directions by using weights wᵢ given by the following equations:

wₓ=aₓ·Sₓ

w_{y}=a_{y}·S_{y}

w_{z}=a_{z}·S_{z}

where aᵢ are adjustment factors that adjust the relative contribution of the rotations around the three axes. Generally, this means that the weights wᵢ in respect of each axis are not identical.

The adjustment factors may all have the same value, which may be one, to provide an equal contribution, or their ratios may be varied to some degree. So that the rotation around each axis does provide some contribution, no adjustment factor is less than a fifth of any other, i.e. the ratio of any pair of adjustment factors is in the range from 0.2 to 5.

Since weights wᵢ are applied to rotation around each axis, what matters is their relative size, in the sense that a common scaling applied to all the weights wᵢ simply scales the overall magnitude of the blur measure M. Thus, the weights wₓ and w_{y} are scaled relative to the weight w_{y} by the equations:

(wₓ/w_{z})=(R_{y}/π·R_{y})·(T/F_{y})·(aₓ/a_{z})

(w_{y}/w_{z})=(Rₓ/π·R_{y})·(T/Fₓ)·(a_{y}/a_{z})

The blur measure M is derived differently depending on whether the image sensor 10 is globally shuttered or rolling shuttered, to take account of the differing exposures in each case, as follows.

The image sensor 10 may be globally shuttered. In that case, the entire image, including each row, is exposed at the same time. This means that each pixel experiences the same rotation across the exposure time. In this case, the blur measure M is simply the blur value B that is the weighted sum described above derived from the rotation detected over the exposure time of the image sensor 10. The amount of rotation about each axis used to derive the blur value B is an integral of the angular velocity about that axis detected by the gyroscope sensor 15a over the exposure time.

The image sensor 10 may be rolling shuttered. In that case, rows of pixels are exposed successively and read out sequentially. Hence, the rows of pixels have successively different exposure times, albeit having exposure times of the same length. This means that each row of pixels may experience a different rotation across its respective exposure time as the motion of the camera unit 2 changes.

In this case, a pixel blur B that is the weighted sum described above is derived in respect of in respect of lines of the image that are exposed at different times from the rotation detected over the exposure times of those lines. This may be done by windowing the angular velocity detected by the gyroscope sensor 15a by a “blur window” that corresponds to the exposure time of successive lines. The amount of rotation about each axis used to derive the blur value B in respect of the line is an integral of the angular velocity about that axis detected by the gyroscope sensor 15a over the exposure time of the line. The length of the blur window is determined by the exposure time of the camera unit 2 and the sampling rate of the gyroscope sensor 15a. For example, if the exposure time is 5 ms and the sampling rate of the gyroscope sensor 15a is 1 kHz, then the blur window has a length of 5 measurements from the gyroscope sensor 15a. This allows the blur values B to track the motion that occurs during the overall readout time of the image.

In practice the sampling rate of the gyroscope sensor 15a may be insufficient to derive a different blur value for every line of pixels. That is, the blur window is updated at the sampling rate of the gyroscope sensor 15a resulting in derivation of blur values B at that sampling rate. For example, at a typical frame rate of 30 fps and a sampling rate of the gyroscope sensor 15a of 1 KHz, then 33 blur values B are derived in respect of an image.

By way of illustration, FIG. 3 shows a sample image and FIG. 4 illustrates the pixel blurs generated from the angular rotation generated during the capture of that sample image. In particular, FIG. 4 illustrates the pixel blurs Pₓ, P_{y} and P_{z} in respect of the angular rotation about each axis that are combined to derive the blur value B as described above. In the case of this sample image, FIG. 4 shows that (1) the pixel blurs Pₓ, P_{y} and P_{z} in respect of the rotation about the different axes vary from one another, and (2) the degree of blurring, and hence the blur value B, is greater in the middle of the image than in the top or bottom of the image, both of which effects can be seen in the sample image itself in FIG. 3.

The blur measure M for the image as a whole is derived as a combination of the blur values B generated across the overall image. This combination may be a weighted sum of the blur values B. For example, the blur measure M may be derived in accordance with the equation

M=Σ(xⱼ·Bⱼ)

where Bⱼ is the i-th blur value, xⱼ is a weight in respect of the i-th blur value and the summation occurs over all the blur values generated for an image.

In one possibility, the weights are the same, for example taking the value of one.

In another possibility, the weights may take account of the perception of blur to a viewer. In one example of such a perceptually influenced weighting, the weights xⱼ may have a value of zero when the blur value Bⱼ is below a perception threshold and that increase with the blur value above the perception threshold. This takes account of an observation that people do not tend to perceive low levels of blur. In another example of such a perceptually influenced weighting, the weights xⱼ may have that increase with the blur value Bⱼ up to a saturation threshold of the blur value Bⱼ above which the weights xⱼ have a constant value. This takes account of an observation that people tend to perceive blur up to a saturation point after which further increases in blur are not perceived.

For example, both these examples of perceptually influenced weighting may be implemented by using weights xⱼ that are a sigmoid function of the blur values Bⱼ, for example as shown in FIG. 5.

An alternative option for taking account of such saturation in the perception of blur is for the blur values B in respect of different lines to be clipped at a saturation threshold, prior to being combined. In that case, they may be combined simply by summation.

The image capture operation in which such a blur measure M is used will now be described.

A first image capture operation performed by the control circuit 12 is shown in FIG. 6 and performed as follows.

This example is intended for a wearable camera in which the image capture operation is performed intermittently without triggering by a user, as described above. In this case, the image sensor 10 and the gyroscope sensor 15a may be powered down between performances of the image capture operation. Thus, in the first step Sa-1 the image sensor 10 and the gyroscope sensor 15a are supplied with power so that the image sensor 10 starts to capture images and the gyroscope sensor 15a starts to detect the angular motion of the camera unit 2. Thereafter, the following steps are performed in an exposure selection stage used to derive the desired exposure.

In step Sa-2, a still image is captured. During the image capture, the exposure is controlled, the exposure taking a predetermined initial value the first time that step Sa-2 is performed. The captured image is stored in the buffer 14. As discussed above, the exposure is controlled by varying the exposure time of the image sensor 10, and optionally also the aperture if the lens assembly 11 permits that.

At the same time as the image is captured in step Sa-2, in step Sa-3 the angular motion of the camera unit 2 is detected by the gyroscope sensor 15a.

In step Sa-4, the blur measure M in respect of the captured image is derived from the angular motion detected in step Sa-3, in the manner described above. As will be described below, steps Sa-2 to Sa-4 are repeated to capture plural images during the exposure selection stage, resulting in separate blur measures M in respect of each image being derived in repeated performances of step Sa-4. All the thus-derived blur measures M are stored for use in step Sa-9 as will be described below.

In step Sa-5, a brightness measure of the brightness of the captured image is derived from the image captured in step Sa-2. This effectively uses the image sensor 10 as a light sensor for determining the brightness of illumination. The brightness may be measured by the luminance of the image or any other type of brightness measure. The measured brightness may be the overall brightness. In step Sa-5, as an alternative to the brightness measure being derived from the captured image, the brightness measure may be derived from a light sensor separate from the image sensor 10 that measures the brightness of illumination, for example a TTL (through the lens) light sensor.

The brightness measure may be derived from the image in any manner suitable for automatic exposure control. For example the brightness measure might in the simplest case be the average brightness of the image, or in more complicated case be derived from the brightness of areas of the captured image weighted by an exposure mask. Such an exposure mask comprises different weights corresponding to different areas of the image. This causes the response of the exposure control to be biased towards areas which have a relatively high weight, causing those areas to be more correctly exposed, at the expense of areas having a relatively low weight to be less correctly exposed.

In step Sa-6, the brightness measure is analysed to determine if the exposure has converged to the desired level taking into account the brightness measure. This analysis may be performed in accordance with any automatic exposure technique. For example, the brightness measure may be compared to a target level to determine if the exposure been brought to that target level. If not, then the method returns via step Sa-7 to steps Sa-2 and Sa-3 so that another image is captured.

In step Sa-7, the exposure (exposure time and, if variable, aperture) is adjusted in accordance with the automatic exposure technique. For example, the adjustment may drive the brightness measure for the subsequently captured image towards the target level, by using difference between the brightness measure from step Sa-5 and the target level as a feedback parameter for the adjustment.

In this manner, steps Sa-6 and Sa-7 cause step Sa-2 to be performed repeatedly to capture images in a cycle with the exposure of the captured images being varied in dependence on the brightness measures of previously captured images.

The camera unit 2 may typically also perform an auto-white balance (AWB) procedure. In that case, steps Sa-5 to Sa-7 may also adjust the white balance (colour balance) by step Sa-5 additionally comprising derivation of an appropriate an colour measure indicating the white balance, step Sa-6 also involving analysis of the colour measure to determine if AWB convergence has occurred, and step Sa-7 also involving adjustment of the colour balance, for example by adjustment of the relative gain of different colour channels. In a similar manner, if the lens assembly 11 provides a variable focus that is controllable, rather than a fixed focus, then an autofocus procedure may be also be performed at the same time.

When it is determined in step Sa-6 that the exposure has converged, the method proceeds to step Sa-8 in which an exposure (exposure time and, if variable, aperture) for a subsequent capture stage is initially selected as the exposure to which convergence has occurred in the preceding steps. Thus, in itself, step Sa-8 selecting an exposure for the capture stage on the basis of the determined brightness of illumination of the captured images alone.

In step Sa-9, the degree of blurring for future capture of images is predicted from the plural blur measures M derived in step Sa-4 from the motion detected during the capture of images in the repeated performances of step Sa-2. The prediction may be performed by deriving a predicted blur measure Mp in any manner, for example by taking a simple average of the plural blur measures M, by low-pass filtering the blur measures M, or by a prediction that weights more recent blur measures M more greatly on the basis that they have a greater predictive power.

In step Sa-10, an exposure for the subsequent capture stage is selected taking into account the degree of blurring predicted in step Sa-9. In the event that the degree of blurring indicated by the predicted blur measure M is acceptable, then in step Sa-10 the exposure (exposure time and, if variable, aperture) for the subsequent capture stage is selected to be that initially selected in step Sa-8.

On the other hand, in the event that the degree of blurring indicated by the predicted blur measure M is unacceptable, then in step Sa-10 the exposure time for the subsequent capture stage is reduced from the exposure time initially selected in step Sa-8. The aperture, if variable, may be controlled to maintain the same value to maximise depth of field, or to increase so as to limit the overall reduction in exposure.

The reduction in the exposure time is performed because that limits the amount of motion blur. This may be done at the expense of some degree of under-exposure on the premise that a darker image is preferable to the user than a blurry one or a noisy one if the reduced exposure is compensated by increased gain.

The determination in step Sa-10 of whether or not the predicted degree of blurring is acceptable may be made by comparing the blur measure M representing the predicted degree of blurring with a threshold. That threshold may be selected based on experimental observation of image capture of typical scenes under typical operating conditions. The threshold may be set in a number of ways, some non-limitative examples being as follows. The threshold may be fixed. The threshold may be dependent on the exposure time initially selected in step Sa-8, for example being increased to allow increased blurring when the exposure time is relatively high on the basis that users may be more accepting of a blurry image if it has high brightness. The threshold may be set or adjusted by the user. The threshold may be adjusted to manage power consumption and hence battery life.

In this manner, as Sa-10 can reduce the exposure time for the capture stage from that selected in step Sa-8, the overall effect of steps Sa-8 and Sa-10 is to select the exposure time for the capture stage on the basis of both (a) the determined brightness of illumination of the captured images, and (b) the predicted blur measure Mp and hence also the detected motion from which it is derived.

Thereafter, the following steps are performed in a capture stage using the exposure selected in the exposure selection stage.

In step Sa-11, a still image is captured. In at least the first performance of step Sa-11, the exposure (exposure time and, if variable, aperture) is that selected in the exposure selection stage. The captured image is stored in the buffer 14.

At the same time as the image is captured in step Sa-11, in step Sa-12 the angular motion of the camera unit 2 is detected by the gyroscope sensor 15a.

In step Sa-13, the blur measure M in respect of the captured image is derived from the angular motion detected in step Sa-11, in the manner described above.

In step Sa-14, it is determined whether the image captured in step Sa-11 is of acceptable quality, taking into account the blur measure M derived in step Sa-13. The blur measure M may be taken into account in various ways. Two non-limitative options are as follows.

In some options, the determination takes account of only the blur measure M derived in step Sa-13, as for example in the following first and second options.

The first option is simply to compare the blur measure M with a threshold. In that case, the blur measure M being below the threshold may indicate acceptable quality and vice versa.

The second option is to take account of the blur measure M in some more complicated way.

In other options, the determination also takes account of one or more measures of another parameter representing quality of the image as for example in the following third and fourth options. By way of example, suitable parameters include a brightness measure of the brightness of the captured image derived from the image as discussed above; a measure indicating how well exposed the image is; or another measure of the light conditions including the colour measure used in the AWB procedure.

The third option is to derive a quality metric that combines the blur measure with the one or more other measures. The combination may be performed in any manner, for example a weighted sum of the measures. Typically the blur measure will have the dominant effect on the quality metric. Then, the quality metric will be compared with a threshold.

A fourth option is to have separate conditions on the blur measure M (for example comparing it with a threshold as in the first option), and on measures of other parameters.

In the event that it is determined in step Sa-14 that the image is of acceptable quality, then the method proceeds to step Sa-15 in which the image captured in step Sa-11 is stored in the memory 13.

However, in the event that it is determined in step Sa-14 that the image is not of acceptable quality, then the method proceeds back to steps Sa-11 and Sa 12, via steps Sa-16 and Sa-17 which will be described below. In this manner, steps Sa-11 to Sa-14 are repeated until an image of acceptable quality is captured and then stored in step Sa-15. The overall result is that the image stored in the memory 13 is of acceptable quality taking into account the degree of blurring indicated by the detected motion.

Steps Sa-16 and Sa-17 are used to reduce the exposure time in the event that the detected motion is not indicative of an acceptable degree of blurring over an extended period of time, as follows.

In step Sa-16, it is determined whether a predetermined period has elapsed since the first time an image was captured in step Sa-11. If not then the method proceeds directly to steps Sa-11 and Sa-12 to repeat the image capture.

However, if it is determined step Sa-16 that a predetermined period has elapsed, then the method proceeds to step Sa-17 in which the exposure time to be used in step Sa-11 is reduced from that previously used, as originally selected in the exposure selection stage. Thereafter, step Sa-11 is performed with the reduced exposure time. The aperture, if controlled, may maintain the same value to maximise depth of field, or may be increased to limit the overall reduction in exposure.

The exposure time is reduced on the basis that the failure to obtain an acceptable degree of blurring over the predetermined period suggests that the unacceptable blurring is likely to continue. Hence the reduction in the exposure time is performed because that limits the amount of motion blur. This is done at the expense of some degree of under-exposure on the premise that a darker image is preferable to the user than a blurry one, or a noisy one if the reduced exposure is compensated by increased gain.

In step Sa-16, although the amount of reduction of exposure time may be predetermined, advantage may be achieved by amount of reduction of exposure time being dependent on the blur measures M derived in the repeated performances of step Sa-13, for example by increasing the amount of reduction when the blur measures M are relatively high.

Steps Sa-16 and Sa-17 have the advantage of finishing the capture operation when the camera unit 2 is in a state of motion. This has the advantage of reducing power consumption of the camera unit 2, which is particularly important to maximise battery life in a wearable camera. Noise free images require a low gain value which favours longer exposure times, which in turn increases the likelihood of blurry images. However, this method uses the indicated degree of blur to trade off the time spent taking a high quality image against the quality of the image.

In optional step Sa-18, sharpness processing is performed on the image stored in step Sa-5 to increase the sharpness of the stored image. In this step, the sharpness processing may be performed to a degree that is dependent on the blur measure M, for example increasing the degree to which sharpness is increased when the blur measure M is indicative of a relatively high degree of blurring.

Finally, in step Sa-19, the image sensor 10 and the gyroscope sensor 15a cease to be supplied with power.

In the above example, a single blur measure M is derived, combining the detected angular motion around all three axes of rotation. As an alternative, the blur measure may be a combination of the detected angular motion around two axes, for example for the first and second axes. As another alternative, separate blur measures may be derived from the detected angular motion around each axis of rotation. In that case, the image capture operation may be modified to use the separate blur measures with separate conditions on each, for example by comparing each separate blur measure to a threshold, with any one of the blur measures exceeding the threshold being taken to indicate an image of unacceptable quality. However, it has been observed that the combination of the angular motion around each of the three orthogonal axes into a single blur measure in practice use provides better results, because the blur of the image in fact results from a combination of the angular motions around different axes.

A second image capture operation performed by the control circuit 12 is shown in FIG. 7 and performed as follows. The image capture operation implements exposure control by capturing images repeatedly in a cycle and selecting one of those images for storage in the memory 13.

In step Sb-1, an initial value is selected for the image capture operation in step Sb-b-2. The exposure is controlled by varying the exposure time and the exposure gain of the image sensor 10. As discussed above, the exposure is controlled by varying the exposure time of the image sensor 10, and optionally also the aperture if the lens assembly 11 permits that.

In step Sb-2, a still image is captured. During the image capture, the exposure is controlled to be the value for the exposure selected in step Sb-3 for the image captured in the initial performance of step Sb-4, and adjusted in step Sb-10 for the images captured in the subsequent performance of step Sb-4, as described below. The captured images are stored in the buffer 14.

In step Sb-3, a brightness measure 21 of the brightness of the captured image is derived from the captured image. This effectively uses the image sensor 10 as a light sensor for determining the brightness of illumination. The brightness may be measured by the luminance of the image or any other type of brightness measure. The measured brightness may be the overall brightness. In step Sb-3, as an alternative to the brightness measure 21 being derived from the captured image, the brightness measure 21 may be derived from a light sensor separate from the image sensor 10 that measures the brightness of illumination, for example a TTL (through the lens) light sensor.

The brightness measure 21 may be derived from the image in any manner suitable for automatic exposure control. For example the brightness measure 21 might in the simplest case be the average brightness of the image, or in more complicated case be derived from the brightness of areas of the captured image weighted by an exposure mask. Such an exposure mask comprises different weights corresponding to different areas of the image. This causes the response of the exposure control to be biased towards areas which have a relatively high weight, causing those areas to be more correctly exposed, at the expense of areas having a relatively low weight to be less correctly exposed.

Steps Sb-9 and Sb-10 cause images to be captured repeatedly in a cycle with control of the exposure on the basis of the brightness measure 21. Sb-4 to Sb-8 are performed between steps Sb-3 and Sb-9 but will be described after steps Sb-9 and Sb-10 as they modify the exposure control effected by steps Sb-9 and Sb-10, on the basis of the detected motion 22 of the camera unit 2 detected by the motion sensor 15a.

In step Sb-9, the brightness measure 21 is compared to a target level to determine if the exposure has converged to bring the brightness measure 21 to the target level. If not then the method returns via step Sb-10 to capture another image in step Sb-2. In step Sb-10, the exposure (exposure time, and if controllable the aperture) is adjusted to drive the brightness measure 21 for the subsequently captured image towards a target level. The difference between the brightness measure 21 from step Sb-3 and the target level is used as a feedback parameter for this adjustment. In this manner, step Sb-2 is performed repeatedly to capture images in a cycle with the exposure of the captured images being controlled in dependence on the brightness measures 21 of previously captured images determined in step Sb-3.

The camera unit 2 may typically also perform an auto-white balance (AWB) procedure. In that case, steps Sb-3, Sb-9 and Sb-10 may also adjust the white balance (colour balance) by step Sb-3 additionally comprising derivation of appropriate an colour measure indicating the white balance, step Sb-9 also involving analysis of the colour measure to determine if AWB convergence has occurred, and step Sb-10 also involving adjustment of the colour balance, for example by adjustment of the relative gain of different colour channels.

The buffer 14 may temporarily buffer all the images captured in the cycle, or in the case that it has a limited size, may temporarily buffer a group of two or more images, captured most recently.

It will now be described how the exposure time is also controlled on the basis of the detected motion 22, for the purpose of reducing motion blur.

Advantage is achieved by using the use of the gyroscope sensor to detect angular motion around three axes of rotation and to derive a blur measure representing the degree of blurring for captured images from the angular motion, as described above.

More generally in this example, the detected motion 22 may represent the movement and/or orientation of the camera unit 2, at least at the time the current image was captured in step Sb-2, and optionally over a period beforehand, since the convergence occurs over plural frames in the cycle. The detected motion 22 used in steps Sb-4 to Sb-8 may include three rotational degrees of freedom and/or two translation degrees of freedom parallel to the image plane. Motion in the third translation degree of freedom along the optical axis may be detected by a motion sensor but has a minimal impact on motion blur. The detected motion 22 can be used to categorise different types of movement and is normalised using previous readings.

For example, movement may be calculated from a motion sensor in the form of a 3-axis accelerometer, integrated over time. Similarly, orientation may be calculated using the same accelerometer to establish a baseline orientation, and then calculating the current offset.

Steps Sb-4 to Sb-6 implement a first approach to controlling exposure time on the basis of the detected motion 22.

In step Sb-4, a predicted exposure time 23 corresponding to the target level of the brightness measure is predicted. This may be deferred until after capture of a few images, as the accuracy of the prediction will increase. The predicted exposure time 23 is a prediction of the exposure time to which the image sensor 10 will converge. The predicted exposure time 23 may be obtained by extrapolating from the current exposure time on the basis that it is proportionate to the ratio of the current level of the brightness measure 21 to the target level of the brightness measure 21 and assuming the convergence is linear. This prediction saves time and power, rather than waiting for the image sensor 10 to converge fully.

In step Sb-5, it is determined from the detected motion 21 and the predicted exposure time whether there would be an unacceptable degree of blurring of the image at the predicted exposure time 23.

Particular advantage is achieved by making this determination on the basis of the blur measure M as describe above, for example by comparing blur measure M with a threshold.

Alternatively, this determination may be made by comparing the detected motion 22 with a motion threshold for what movement patterns would cause significant motion blur for the specific image sensor 10 and lens assembly 11 being used. The detected motion 22 may be taken to be indicative of an unacceptable degree of blurring of the image when the detected motion exceeds a motion threshold, that may be dependent on the predicted exposure time 23.

The motion blur response varies across different degrees of freedom and so the analysis is performed on the basis of the degrees of freedom taken individually, each having a given threshold. The threshold may be established by a combination of calculating the pixel movement in certain conditions, and experimental observation. For example, a linear velocity of above 1.15 m/s parallel to the image plane might for a given optical system give 4 pixel motion blur on an object at 4 m distance with a 5 ms exposure time.

That being said, combining all the movement values into a single dimension score and comparing this to a simple threshold against works experimentally. Therefore, the analysis may be performed on the basis of a combined measure derived from each of the degrees of freedom of the detected motion that is compared to a single motion threshold.

If step Sb-5 determines there would be an unacceptable degree of blurring, then the exposure time is limited to a capped level below the predicted exposure by proceeding to step Sb-6 in which it is checked whether the current exposure time has reached that capped level and if so the method proceeds to step Sb-11.

Such limitation of the exposure time to a capped level limits the motion blur to an acceptable level at the expense of some degree of under-exposure. The premise is that a darker image is preferable to the user than a blurry one, or a noisy one if the reduced exposure is compensated by increased gain. Thus overall the quality of images captured by the camera unit 2 is improved.

Whilst the capped level used in step Sb-6 could have fixed level, advantage is obtained by setting the capped level to be dependent on the detected motion 22 or the blur measure M, and also the brightness measure 21, although remaining below the predicted exposure 23. In this way the capped level may be derived as a trade-off between movement, and how dark the image would appear at that capped level of exposure based on the predicted exposure 23 (or how noisy if reduced exposure is compensated by increased gain). For example, if the algorithm calculates that, at a desired capped level, the image would be much too dark, it will use a higher capped level. To give a specific example, if the motion threshold is exceeded, and a 5 ms capped level would be between a factor of 0.25 and 1 of the predicted exposure 23 at max analog gain, then such a 5 ms capped level is used or else, the method is repeated with capped levels of 20 ms, 80 ms etc.

On the other hand, if either of steps Sb-5 or Sb-6 have a negative result the method proceeds to step Sb-7.

Steps Sb-7 and Sb-8 implement a second approach to controlling exposure time on the basis of the detected motion 22.

In step Sb-7, it is determined whether the detected motion 22 is below a stillness threshold. Similarly to the motion threshold used in step Sb-5, this may be performed on the basis of the degrees of freedom taken individually or in combination, the comments above relating to this choice in respect of the motion threshold applying equally to the stillness threshold in step Sb-7. The detected motion 22 is therefore analysed to see if the camera unit 2 is still. Historical readings may be used as well to confirm the detected motion 22 is below the stillness threshold over a period, requiring a succession of images to be still obtaining a positive result in step Sb-7. Step Sb-7 may similarly be performed on the basis of the blur measure M derived as described above.

In step Sb-8, there is made on the basis of the determination in step Sb-7 a setting for an exposure limit representing the maximum limit to which the exposure time may be adjusted in step Sb-5. In response to the detected motion 22 not being below the stillness threshold then the exposure time is limited to a first exposure limit, which may take a normal value. In response to the motion of the camera unit detected by the motion sensor being below a stillness threshold limiting the exposure time to a second exposure limit that exceeds first exposure limit, that may be a long exposure time achieved by setting the image sensor 10 to a lower frame rate than standard, e.g. 3 fps. The setting made in step Sb-8 is supplied to step Sb-9. In step Sb-9, convergence is judged to have occurred when the set first or second exposure limit is reached (as an alternative to the brightness measure 23 reaching the target level). In that case, the method proceeds to step Sb-11.

Steps Sb-7 and Sb-8 therefore allow the exposure time to be increased to accommodate a low light scene when the detected motion 22 is indicative of motion blur not being generated in the captured image. If the image sensor 10 is significantly underexposing even when allowed to converge automatically, then, if the camera unit 2 is sufficiently still, it will automatically switch into a long exposure mode. In this mode, there may be object motion blur from scene objects, but the stillness of the camera unit 2 should mean there is not motion blur from motion of the camera unit 2. The reasoning is that the user prefers a scene with object motion blur to a dark scene.

There will now be described steps Sb-11 to Sb-13 which result in one of the images captured during the cycle and buffered in the buffer 14 being stored in the memory 13. The captured image stored in the memory 13 could be the final image captured during the cycle, but it has been appreciated that it might in some circumstances be the case that the final image does not have the best image quality, due to motion changes in the scene being imaged, and other changes in conditions, as between the captured images.

Accordingly in step Sb-11, a quality metric in respect of each of the images buffered in the buffer 14 is calculated as a basis for deciding which buffered image should be stored. Subsequently, in step Sb-13, the image buffered in the buffer 14 having the highest quality metric is stored in the memory 13 and the other images buffered in the buffer 14 are discarded. For equal scoring images, the latest image is chosen.

The nature of the quality metric is as follows. The quality metric may take into account the brightness measure of the image and at least one further parameter. In general, the quality metric could combine any further parameters that are representative of image quality. Typically the at least one further parameter includes at least one parameter of the image, for example the colour balance of the image and/or a measure of the blur of the image. Also the at least one further parameter may include the detected motion 22 of the camera unit 2 detected by the motion sensor at the time of image capture, or may be the blur measure M derived as describe above.

Thus the quality metric may be a composite score including for example any combination of: measures indicating how well exposed the image is; another measure of the light conditions including the colour measure used in the AWB procedure.

Merely by way of example, one possible quality metric is 1000 minus the average motion variance of the detected motion 22 compared to a 2 s average window, minus a penalty of 300 if the image has not converged (AWB and exposure) minus the difference of the brightness measure 21 (for example the average brightness) from the target level for the brightness measure, which is a proxy for exposure. The movement variance penalty is not applied if the exposure has been capped to reduce motion blur.

In optional step Sb-12 carried out before storage of an image in step Sb-12, the difference between the exposure corresponding to the target level of the brightness measure and the exposure of the stored image is calculated and the image is adjusted by a gamma curve that is selected in dependence on the calculated difference. Step Sb-11 may be performed during the process of creating a JPEG file from the raw data of the image from the image sensor 10, in the case that the image is stored in a JPEG format. This step partially lightens the image back to where it would have been if taken using the natural exposure. By way of example, a gamma curve may be selected where the mapped value at 100 is roughly equivalent to the mapped value if the image had been allowed to be taken with natural exposure and the standard gamma curve.

In an alternative according to the first aspect of the present invention, there is provided a method of controlling a camera unit that comprises an image sensor arranged to capture the images and a motion sensor arranged to detect motion of the camera unit, the method comprising:

capturing still images repeatedly in a cycle;

deriving a brightness measure of the overall brightness of captured images, and, in said step of capturing still images repeatedly in a cycle, controlling the exposure time on the basis of both the brightness measure and the motion of the camera unit detected by the motion sensor.

In this method, the exposure time is controlled on the basis of not only the brightness measure but also the motion of the camera unit detected by a motion sensor with which the camera unit is provided. The brightness measure may be used in a similar manner to known automatic exposure control systems. However, advantage is obtained by additionally taking account of the motion. This allows the exposure control to be improved in a number of ways.

The use of the detected motion allows the exposure control to be adapted to take account of the detected motion in a way that the exposure may be optimised without image quality being impacted by motion blur. For example, the exposure time may be limited when the detected motion is indicative of motion blur being generated in the captured image. Conversely, the exposure time may be increased to accommodate a low light scene when the detected motion is indicative of motion blur not being generated in the captured image.

Furthermore, this improvement reduces the requirement for a mechanical OIS system that would increase the bulk and cost of the camera or for an image processing systems that would increase the processing requirements and cost of the associated circuitry. Similarly, this improvement reduces the requirement for a flash unit or for the provision of a still or stabilised platform.

This has particular advantage when applied to a camera unit in which the method is performed intermittently without triggering by a user, for example a camera unit that comprises plural sensors arranged to sense physical parameters of the camera unit or its surroundings, in which case the method may be performed intermittently in response to the outputs of the sensors. As discussed above, in such a camera unit the problems addressed by the first aspect of the present invention are exacerbated, because image capture occurs whilst the user moves naturally through variable lighting conditions, without the user taking action to improve image quality. Thus, the benefits obtained are of more importance.

The method may optionally involve the following features, applied in any combination.

The method may be performed intermittently without triggering by a user.

The camera unit may comprise plural sensors arranged to sense physical parameters of the camera unit or its surroundings, and the method may be performed intermittently in response to the outputs of the sensors.

In an example of the exposure time being limited when the detected motion is indicative of motion blur being generated in the captured image, the step of controlling the exposure time may comprise:

controlling the exposure time on the basis of the brightness measure to drive the brightness measure towards a target level;

after capturing at least one image, predicting the exposure time corresponding to the target level of the brightness measure; and

in response to the predicted exposure time and the detected motion being indicative of an unacceptable degree of blurring of the image, limiting the exposure time to a capped level below the predicted exposure time.

For example, the predicted exposure time and the detected motion may be taken to be indicative of an unacceptable degree of blurring of the image when the detected motion exceeds a motion threshold, that may optionally be dependent on the predicted exposure time.

The capped level may be dependent on the motion of the camera unit detected by the motion sensor.

The capped level may also be dependent on the brightness measures.

In an example of the exposure time being increased to accommodate a low light scene when the detected motion is indicative of motion blur not being generated in the captured image, the step of controlling the exposure time may comprise controlling the exposure time on the basis of the brightness measure to drive the brightness measure towards a target level, and, during that control, in response to the motion of the camera unit detected by the motion sensor not being below a stillness threshold limiting the exposure time to an exposure limit, and in response to the motion of the camera unit detected by the motion sensor being below a stillness threshold limiting the exposure time to a second exposure limit that exceeds first exposure limit.

However, these examples are not limitative and the method may take account of the motion in other ways. An alternative approach is for the method to vary the target level in dependence on the motion of the camera unit detected by the motion sensor. For example, the target level may be decreased in response to a predicted exposure time, derived as discussed above, and the detected motion, taken together, being indicative of an unacceptable degree of blurring of the captured image, and vice versa.

The detected motion may have three rotational degrees of freedom and/or two translation degrees of freedom parallel to the image plane.

The detected motion may be analysed on the basis of the degrees of freedom taken individually.

The detected motion may be analysed on the basis of a combined measure derived from each of the degrees of freedom of the detected motion.

The method may further comprise storing one of the images captured during the cycle and discarding the other images captured during the cycle.

The method may further comprise calculating the difference between the exposure corresponding to the target level of the brightness measure and the exposure of the stored image, and adjusting the image by a gamma curve that is selected in dependence on the calculated difference.

The one of the images captured during the cycle that is stored may be the final image captured during the cycle.

The method may further comprise buffering at least some of the captured images, and deriving a quality metric in respect of the buffered images, the quality metric taking into account the brightness measure of the image and at least one further parameter, and the one of the images captured during the cycle that is stored being the buffered image having the highest quality metric.

In the alternative of the first aspect of the invention, there is further provided a camera unit comprising: an image sensor; a motion sensor arranged to detect motion of the camera unit; and a control circuit for controlling the camera unit, the control circuit being arranged to perform an image capture operation comprising steps according to the method in accordance with the alternative of the first aspect of the invention.

1. A method of controlling a camera unit that comprises an image sensor arranged to capture still images and a motion sensor arranged to detect motion of the camera unit, the method comprising:
capturing still images;
determining the brightness of illumination during the capture of images;
detecting motion of the camera unit during the capture of images; and
during the capture of images, controlling the exposure time in dependence on both the determined brightness of illumination of the captured images and the detected motion; and
storing a captured image.

2. A method according to claim 1, wherein said step of controlling the exposure time in dependence on both the determined brightness of illumination of the captured images and the detected motion comprises initially selecting the exposure time on the basis of the determined brightness of illumination but reducing the exposure time from that selected exposure time in the event that the detected motion is indicative of an unacceptable degree of blurring.

3. A method according to claim 1, wherein the step of capturing images includes an exposure selection stage and a subsequent capture stage, wherein
the exposure selection stage comprises:
capturing images with varying exposure times and determining the brightness of illumination of the captured images; and
selecting an exposure time for the capture stage on the basis of the determined brightness of illumination of the captured images, and
the capture stage comprises:
capturing at least one image with the exposure time selected in the exposure selection stage and storing one of the images captured in the capture stage.

4. A method according to claim 3, wherein
the exposure selection stage further comprises detecting motion of the camera unit during the capture of images, and
the step of selecting an exposure time in the exposure selection stage is performed on the basis of both the determined brightness of illumination of the captured images and the detected motion.

5. A method according to claim 4, wherein the step of selecting an exposure time in the exposure selection stage comprises:
initially selecting an exposure time for the capture stage on basis of the determined brightness of illumination of the images captured with varying exposure times;
predicting the degree of blurring for future capture of images from the motion detected during the capture of images in exposure selection stage,
reducing the exposure time for the capture stage from that selected exposure in the event that the detected motion is indicative of an unacceptable degree of blurring, and using the initially selected exposure time for the capture stage otherwise.

6. A method according to claim 3, wherein the capture stage comprises:
capturing an image with the exposure time selected in the exposure selection stage;
during capture of the image, detecting motion of the camera unit; and
determining whether the image is of acceptable quality taking into account at least the degree of blurring indicated by the detected motion, and either storing the captured image if it is of acceptable quality, or else repeating the steps of capturing an image, detecting motion of the camera unit, and determining whether the image is of acceptable quality until an image of acceptable quality is captured and stored,
wherein if an image of acceptable quality is not captured within a predetermined period, then the step of capturing an image is thereafter performed with an exposure time less than the exposure time selected in the exposure selection stage.

7. A method according to claim 1, wherein the step of determining the brightness of illumination during the capture of images comprises deriving a brightness measure of the brightness of the captured images.

8. A method according to claim 7, wherein the brightness measure is a measure of the overall brightness of the captured images.

9. A method according to claim 1, wherein the motion sensor is a gyroscope sensor and the detected motion of the camera unit is angular motion of the camera unit around at least one axis.

10. A method according to claim 9, wherein the detected motion of the camera unit is angular motion of the camera unit around three orthogonal axes.

11. A method according to claim 9, further comprising deriving at least one blur measure for captured images representing the degree of blurring from the angular motion detected by the gyroscope sensor, and said dependence of the control of the exposure time on the detected motion is dependence on the degree of blurring represented by the at least one blur measure.

12. A method according to claim 11, wherein the at least one blur measure comprises a blur measure derived from a combination of the angular motion around each of three orthogonal axes detected by the gyroscope sensor.

13. A method according to claim 12, wherein said combination of the angular motion around each of three orthogonal axes is a weighted sum of the angular motion around each of three orthogonal axes.

14. A method according to claim 13, wherein the weighted sum of the angular motion around each of the three orthogonal axes has weights in respect of each of the three orthogonal axes that are not identical.

15. A method according to claim 13, wherein the weighted sum of the angular motion around each of the three orthogonal axes has weights in respect of each of the three orthogonal axes that are scaled relative to each other by factors that are based on the amount of blur measured relative to the pixel pitch.

16. A method according to claim 15, wherein
the three orthogonal axes comprise a first and second axes in the plane of the image sensor and a third axis perpendicular to the plane of the image sensor,
the weight in respect of the first axis is scaled relative to the weight in respect of the third axis by the product of (a) the pixel resolution of the image sensor along the second axis divided by the pixel resolution of the image sensor along largest circle that fits in the image, (b) a full turn divided by the angular field of view in a plane containing the second axis, and (c) a first adjustment ratio having a value in the range from 0.2 to 5, and
the weight in respect of the second axis is scaled relative to the weight in respect of the third axis by the product of (a) the pixel resolution of the image sensor along the first axis divided by the pixel resolution of the image sensor along largest circle that fits in the image, (b) a full turn divided by the angular field of view in a plane containing the first axis, and (c) a second adjustment ratio in respect of the third axis having a value in the range from 0.2 to 5, and the ratio of the first to second adjustment ratio having a value in the range from 0.2 to 5.

17. A method according to claim 11, wherein the image sensor is globally shuttered and the blur measure is derived from the angular motion detected by the gyroscope sensor over the exposure time of the image sensor.

18. A method according claim 11, wherein the image sensor is rolling shuttered and the blur measure is a combination of blur values in respect of lines of pixels of the image that are exposed at different times, the blur values being derived from the angular motion detected by the gyroscope sensor over the exposure time of respective lines.

19. A method according to claim 18, wherein said combination of blur values is a weighted sum of the blur values in respect of each line.

20. A method according to claim 19, wherein the weighted sum of the blur values in respect of each line has weights that are zero when the blur value is below a perception threshold and that increase with the blur value above the perception threshold.

21. A method according to claim 19, wherein the weighted sum of the blur values in respect of each line has weights that increase with the blur value up to a saturation threshold above which the weights have a constant value.

22. A method according to claim claim 19, wherein the weighted sum of the blur values in respect of each line has weights that are a sigmoid function of the blur values.

23. A method according to claim 18, wherein the blur values in respect of each line are clipped at a saturation threshold.

24. A method according to claim 1, further comprising performing sharpness processing that increases the sharpness of the stored image to a degree that is dependent on the detected motion.

25. A method according to claim 1, wherein the method is performed intermittently without triggering by a user.

26. A method according to claim 25, wherein the camera unit comprises plural sensors arranged to sense physical parameters of the camera unit or its surroundings, and the method is performed intermittently in response to the outputs of the sensors.

27. A method of controlling a camera unit that comprises an image sensor arranged to capture the images, the method comprising:
capturing still images repeatedly in a cycle and buffering at least some of the captured images;
determining the brightness of illumination during the capture of images, and, in said step of capturing still images repeatedly in a cycle, controlling the exposure on the basis of the determined brightness;
deriving a quality metric in respect of the buffered images; and
storing a buffered image having the highest quality metric and discarding the other buffered images.

28. A method according to claim 27, wherein said step of controlling the exposure comprises controlling the exposure on the basis of the brightness of illumination to drive the brightness of illumination towards a target level.

29. A method according to claim 27, wherein the step of determining the brightness of illumination during the capture of images comprises deriving a brightness measure of the brightness of the captured images.

30. A method according to claim 29, wherein the brightness measure is a measure of the overall brightness of the captured images.

31. A method according to claim 29, wherein the quality metric takes into account the brightness measure of the image and at least one further parameter.

32. A method according to claim 31, wherein the at least one further parameter includes at least one parameter of the image.

33. A method according to claim 32, wherein the at least one further parameter includes at least one of the colour balance of the image and a blur measure of the blur of the image.

34. A method according to claim 31, wherein the camera apparatus further comprises a motion sensor arranged to detect motion of the camera unit, and the at least one further parameter includes the motion of the camera unit detected by the motion sensor at the time of image capture.

35. A method according to claim 27, wherein the camera apparatus further comprises a motion sensor arranged to detect motion of the camera unit, and the quality metric takes into account the blurring of the image indicated by the detected motion.

36. A method according to claim 35, wherein the motion sensor is a gyroscope sensor and the detected motion of the camera unit is angular motion of the camera unit around at least one axis.

37. A method according to claim 36, wherein the detected motion of the camera unit is angular motion of the camera unit around three orthogonal axes.

38. A method according to claim 36, further comprising deriving at least one blur measure representing the degree of blurring for captured images from the angular motion detected by the gyroscope sensor, the quality metric takes into account the blurring of the image represented by the at least one blur measure.

39. A method according to claim 38, wherein the at least one blur measure comprises a blur measure derived from a combination of the angular motion around each of three orthogonal axes detected by the gyroscope sensor.

40. A method according to claim 39, wherein said combination of the angular motion around each of three orthogonal axes is a weighted sum of the angular motion around each of three orthogonal axes.

41. A method according to claim 27, wherein the method is performed intermittently without triggering by a user.

42. A method according to claim 41, wherein the camera unit comprises plural sensors arranged to sense physical parameters of the camera unit or its surroundings, and the method is performed intermittently in response to the outputs of the sensors.

43. A camera unit comprising:
an image sensor arranged to capture still images;
a motion sensor arranged to detect motion of the camera unit; and
a control circuit for controlling the camera unit, the control circuit being arranged to perform an image capture operation comprising:
capturing still images;
determining the brightness of illumination during the capture of images;
detecting motion of the camera unit during the capture of images; and
during the capture of images, controlling the exposure time in dependence on both the determined brightness of illumination of the captured images and the detected motion; and
storing a captured image.

44. A camera unit comprising:
an image sensor
a control circuit for controlling the camera unit, the control circuit being arranged to perform an image capture operation comprising:
capturing still images repeatedly in a cycle and buffering at least some of the captured images;
determining the brightness of illumination during the capture of images, and, in said step of capturing still images repeatedly in a cycle, controlling the exposure on the basis of the determined brightness;
deriving a quality metric in respect of the buffered images; and
storing a buffered image having the highest quality metric and discarding the other buffered images.

45. A camera comprising a housing and a camera unit according to claim 43 mounted in a housing.
